(19) United States
(12) Patent Application Publication
(10) Pub. No.: US 2025/0269691 A1
(43) Pub. Date: Aug. 28, 2025

(54) PNEUMATIC TIRE

(71) Applicant: The Yokohama Rubber Co., LTD., Kanagawa (JP)

(72) Inventor: Takafumi Gohara, Kanagawa (JP)

(21) Appl. No.: 19/042,937

(22) Filed: Jan. 31, 2025

(30) Foreign Application Priority Data
Feb. 22, 2024 (JP) 2024-025263

(51) Int. Cl. B60C 11/13; B60C 11/03

(52) U.S. Cl. CPC B60C 11/1307; B60C 2011/0353; B60C 2011/0355; B60C 2011/1338

(57) ABSTRACT

In a pneumatic tire including a groove in an outer surface of a tread, the groove has a bottom forming a maximum depth, side walls extending from a contact surface of the tread to a side of the bottom, and a projection portion projecting into the groove from at least one side wall. A regular state in which the tire is mounted on a rim and inflated to a regular internal pressure is defined, a ground contact state in which the tire in the regular state contacts a flat surface and is loaded with 100% of a regular load is defined, and when the groove is directly below ground contact in the ground contact state, a groove width (W1a) of the groove at a projection portion position and a groove width (W2a) of the groove at an opening portion position of the groove satisfy W1a/W2a≤0.75.

### CROSS-REFERENCE TO RELATED APPLICATION

This application is based upon and claims the benefit of priority from Japanese Patent Application No. 2024-025263, filed on Feb. 22, 2024, the entire contents of which is incorporated herein by reference.

### TECHNICAL FIELD

The present technology relates to a pneumatic tire suitable as a heavy-duty tire and particularly relates to a pneumatic tire that can effectively reduce stone drilling due to stone biting.

### BACKGROUND

Since a heavy-duty pneumatic tire used for a truck or the like is used not only on-road but also off-road, stone biting may occur in a groove formed in an outer surface of a tread portion. If such stone biting occurs, a stone trapped in the groove gradually moves toward the groove bottom side and eventually reaches the groove bottom. Such a phenomenon is called stone drilling. If the stone reaches the groove bottom, the stone will cause cracks to be generated at the groove bottom. If the cracks at the groove bottom reach a belt layer to damage the belt layer, the durability of the pneumatic tire may be decreased, or the pneumatic tire may not be able to be retreaded.

To reduce such cracks at the groove bottom due to stone biting, providing projection portions projecting into the groove from both side walls of the groove and promoting discharge of the stone by using the projection portions have been proposed (see, for example, Japan Patent No. 5804823 B). Unfortunately, simply providing the projection portions in the groove has not necessarily reduced stone drilling sufficiently.

### BRIEF SUMMARY

The present technology provides a pneumatic tire that can effectively reduce stone drilling due to stone biting.

A pneumatic tire according to an embodiment of the present technology includes: a tread portion extending in a tire circumferential direction and having an annular shape; a pair of sidewall portions disposed on respective both sides of the tread portion; a pair of bead portions each disposed on an inner side of the sidewall portions in a tire radial direction; a carcass layer mounted between the pair of bead portions; a belt layer disposed on a radially outer side of the carcass layer; and a groove formed in an outer surface of the tread portion.

In the pneumatic tire, the groove includes a groove bottom forming a maximum depth portion of the groove, a pair of side walls extending from a road contact surface of the tread portion to a side of the groove bottom, and a projection portion projecting into the groove from at least one side wall of the pair of side walls,

A state in which the pneumatic tire is mounted on a regular rim and inflated to a regular internal pressure is defined as a regular state, a state in which the pneumatic tire in the regular state is brought into contact with a flat surface and loaded with a load of 100% of a regular load is defined as a standard ground contact state, and

When the groove is located in a region directly below ground contact in the standard ground contact state, a groove width W1a of the groove measured at a position of the projection portion and a groove width W2a of the groove measured at a position of an opening portion of the groove satisfy a relationship W1a/W2a≤0.75.

As a result of diligent researches on the relationship between the cross-sectional shape of the groove formed in the outer surface of the tread portion and stone drilling, the present inventor has found that properly designing the cross-sectional shape of the groove in the standard ground contact state is important to reduce stone drilling due to stone biting and has achieved the present technology.

In other words, in the present technology, the groove formed in the outer surface of the tread portion includes the projection portion projecting into the groove from at least one side surface, and when the groove is located in the region directly below ground contact in the standard ground contact state, the groove width W1a of the groove measured at the position of the projection portion and the groove width W2a of the groove measured at the position of the opening portion of the groove satisfy the relationship W1a/W2a≤0.75. This can prevent a stone entering the groove from reaching the groove bottom and effectively reduce stone drilling. As a result, cracks at the groove bottom due to stone biting can be effectively reduced.

In the present technology, the groove formed in the outer surface of the tread portion preferably includes the projection portion projecting into the groove from one side wall of the pair of side walls but preferably includes no projection portion on the other side wall. The groove in which the projection portion is disposed only on one groove wall in this manner can effectively discharge a stone entered in the groove and reduce stone drilling.

When the groove is located in the region directly below ground contact in the standard ground contact state, a groove depth Da of the groove and a height d1a of the projection portion preferably satisfy a relationship 0.10≤d1a/Da≤0.70. Setting the height d1a of the projection portion in the range above in relation to the groove depth Da of the groove can effectively discharge a stone entered in the groove and reduce stone drilling.

A groove depth Da of the groove and a distance Ha from the belt layer to the groove bottom of the groove preferably satisfy a relationship 0.1≤Ha/Da≤0.7 when the groove is located in the region directly below ground contact in the standard ground contact state. Setting the distance Ha from the belt layer to the bottom of the groove in the range above in relation to the groove depth Da of the groove can effectively reduce stone drilling while having sufficient volume of the groove.

In the regular state, a cross-sectional area S2b of the groove from the opening portion of the groove to the projection portion and a cross-sectional area S1b of the groove from the projection portion to the groove bottom preferably satisfy a relationship S1b/S2b≤0.4. Setting cross-sectional area S1b of the groove from the projection portion to the groove bottom in the range above in relation to the cross-sectional area S2b of the groove from the opening portion of the groove to the projection portion causes a stone entered in the groove to be less likely to enter the groove bottom side and can thus reduce stone drilling.

In the regular state, a sum of a distance Hb from the belt layer to the bottom of the groove and a height dib of the projection portion is preferably 6 mm or more. This increases the apparent under-groove rubber gauge during ground contact and can thus reduce stone drilling.

In the regular state, the projection portion preferably has a curved surface at a portion connected to the side wall and a curved surface at a portion connected to the groove bottom and preferably has a bent surface at an end portion in which a surface connected to the side wall and a surface connected to the groove bottom are coupled to each other. Strain concentrates on a portion of the projection portion connected to the side wall and a portion of the projection portion connected to the groove bottom during ground contact. Accordingly, by providing the curved surfaces on these portions, the concentration of strain can be avoided. Meanwhile, by providing the bent surface at an end portion in which a surface of the projection portion connected to the side wall and a surface connected to the groove bottom are coupled to each other, the entry of a stone toward the groove bottom side can be effectively prevented.

In the regular state, a cross-sectional area S3b of the groove from a position of half of a groove depth Db of the groove to the projection portion and a cross-sectional area S1b of the groove from the projection portion to the groove bottom preferably satisfy a relationship S1b/S3b≤0.6. Setting the cross-sectional area S1b of the groove from the projection portion to the groove bottom in the range above in relation to the cross-sectional area S3b of the groove from the position of half of the groove depth Db of the groove to the projection portion causes a stone entered in the groove to be less likely to enter the groove bottom side even in a state where wear has progressed and can thus reduce stone drilling.

A groove width W1b of the groove measured at a position of the projection portion in the regular state is preferably 1 mm or more and 8 mm or less. This can reduce stone drilling while having sufficient volume of the groove.

A groove width W1b of the groove measured at a position of the projection portion in the regular state and the groove width W1a of the groove measured at the position of the projection portion in the standard ground contact state preferably satisfy a relationship W1a/W1b≤0.7. Setting the groove width W1a in the standard ground contact state in the range above with respect to the groove width W1b in the regular state can effectively prevent a stone entered in the groove from reaching the groove bottom.

When the groove is located in the region directly below ground contact in the standard ground contact state, the pair of side walls preferably have a shape bulging toward an inner side of the groove. The pair of side walls having a shape bulging toward the inner side of the groove in the standard ground contact state improves discharging performance for a stone and can reduce stone drilling.

In the present technology, the regular state is a state in which the pneumatic tire is mounted on a regular rim and inflated to a regular internal pressure, and the standard ground contact state is a state in which the pneumatic tire in the regular state is brought into contact with a flat surface and loaded with a load of 100% of a regular load. “Regular rim” refers to a rim defined by a standard for each tire according to a system of standards that includes standards with which tires comply, and is “standard rim” defined by Japan Automobile Tyre Manufacturers Association (JATMA), “Design Rim” defined by The Tire and Rim Association, Inc. (TRA), or “Measuring Rim” defined by European Tire and Rim Technical Organization (ETRTO), for example. “Regular internal pressure” is an air pressure defined by standards for each tire according to a system of standards that includes standards with which tires comply and refers to a maximum air pressure defined by JATMA, refers to the maximum value in the table of “TIRE LOAD LIMITS AT VARIOUS COLD INFLATION PRESSURES” defined by TRA, or refers to the “INFLATION PRESSURE” defined by ETRTO. “Regular load” is a load defined by a standard for each tire according to a system of standards that includes standards with which tires comply and refers to a “maximum load capacity” defined by JATMA, refers to the maximum value in the table of “TIRE LOAD LIMITS AT VARIOUS COLD INFLATION PRESSURES” defined by TRA, or refers to “LOAD CAPACITY” defined by ETRTO.

### BRIEF DESCRIPTION OF THE DRAWINGS

FIG. 1 is a meridian cross-sectional view illustrating a heavy-duty pneumatic tire according to an embodiment of the present technology;

FIG. 2 is a cross-sectional view illustrating a groove formed in an outer surface of a tread portion of the pneumatic tire (in a standard ground contact state) of FIG. 1;

FIG. 3 is a cross-sectional view illustrating the groove formed in the outer surface of the tread portion of the pneumatic tire (in a regular state) of FIG. 1;

FIG. 4 is another cross-sectional view illustrating the groove formed in the outer surface of the tread portion of the pneumatic tire (in the regular state) of FIG. 1; and,

FIG. 5 is a still another cross-sectional view illustrating the groove formed in the outer surface of the tread portion of the pneumatic tire (in the regular state) of FIG. 1.

### DETAILED DESCRIPTION

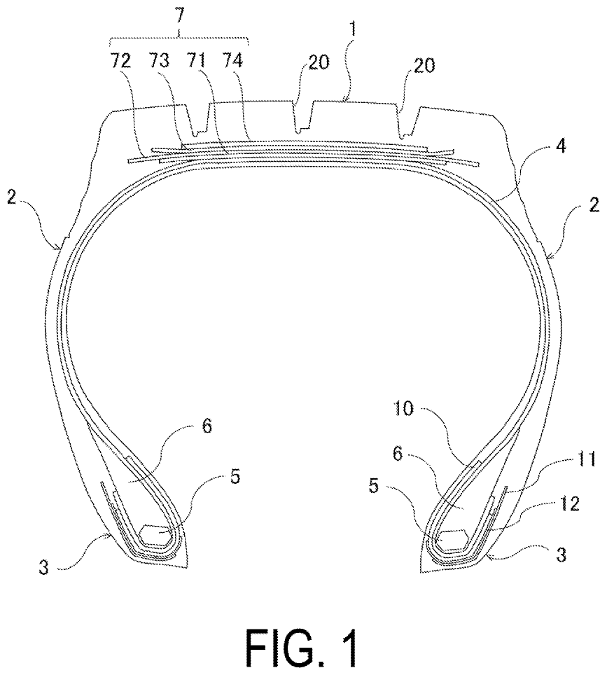

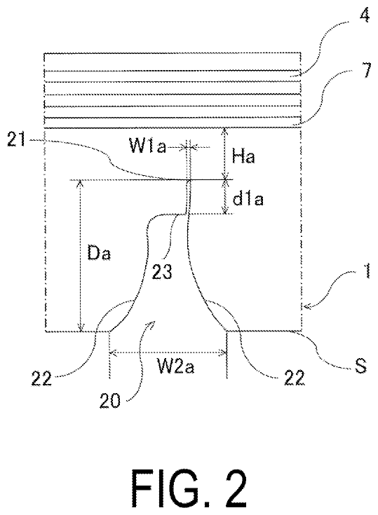

Configurations of embodiments of the present technology will be described in detail below with reference to the accompanying drawings. FIG. 1 illustrates a heavy-duty pneumatic tire according to an embodiment of the present technology, and FIGS. 2 to 5 illustrates the main portion thereof.

As illustrated in FIG. 1, a pneumatic tire of the present embodiment includes a tread portion 1 extending in a tire circumferential direction and having an annular shape, a pair of sidewall portions 2, 2 disposed on both sides of the tread portion 1, and a pair of bead portions 3, 3 disposed on inner sides of the sidewall portions 2, 2 in a tire radial direction.

A carcass layer 4 is mounted between the pair of bead portions 3, 3. Carcass layer 4 includes a plurality of steel cords extending in the tire radial direction and is turned up around a bead core 5 disposed in each of the bead portions 3, 3 from a tire inner side to a tire outer side. A bead filler 6 having a triangular cross-sectional shape and formed of a rubber composition is disposed on the outer circumference of the bead core 5.

Four belt layers 7 are embedded on a radially outer side of the carcass layer 4 in tread portion 1. Each of the belt layers 7 includes a plurality of belt cords (steel cords) inclined with respect to the tire circumferential direction. The belt layers 7 include two central main belt layers 72, 73 with belt cords intersecting with each other, and auxiliary belt layers 71, 74 disposed on a radially inner side and a radially outer side of the main belt layers 72, 73. The inclination angle of the belt cords constituting the main belt layers 72, 73 with respect to the tire circumferential direction is set to range, for example, from 150 to 35°, and the inclination angle of the belt cords constituting the auxiliary belt layers 71, 74 with respect to the tire circumferential direction is set to range, for example, from 15° to 75°.

In the pneumatic tire described above, a steel reinforced layer 10 including a plurality of steel cords is disposed in each bead portion 3 so as to wrap around the carcass layer 4, the bead core 5, and the bead filler 6. Organic fiber reinforced layers 11, 12 are disposed on an outer side of the steel reinforced layer 10 in a tire width direction. Each of the organic fiber reinforced layers 11, 12 includes a plurality of organic fiber cords that are arranged in one direction, and the organic fiber cords constituting the organic fiber reinforced layers 11, 12 are oriented so as to intersect with each other between the layers.

Note that the tire internal structure described above represents a typical example of a heavy-duty pneumatic tire, but the pneumatic tire is not limited thereto.

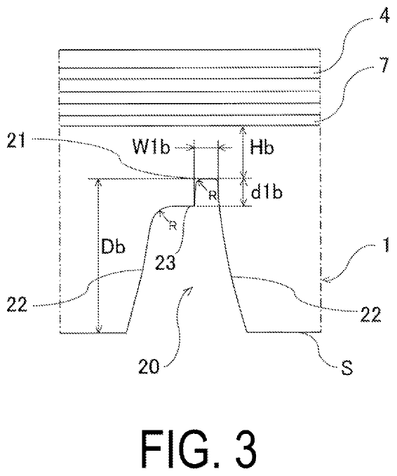

In the pneumatic tire described above, a plurality of grooves 20 (main grooves) extending in the tire circumferential direction are formed in the outer surface of the tread portion 1. As illustrated in FIG. 3, plurality of grooves 20 each includes a groove bottom 21 forming a maximum depth portion of the groove 20, a pair of side walls 22 extending from a road contact surface S of the tread portion 1 toward the groove bottom side, and a projection portion 23 projecting into the groove 20 from at least one side wall 22 of the pair of side walls 22. In the present embodiment, groove 20 includes projection portion 23 projecting into the groove 20 from one side wall 22 but includes no projection portion 23 on the other side wall 22.

Here, a state in which the pneumatic tire is mounted on a regular rim and inflated to a regular internal pressure is referred to as a regular state, and a state in which the pneumatic tire in the regular state is brought into contact with a flat surface and loaded with a load of 100% of a regular load is referred to as a standard ground contact state.

FIG. 2 illustrates the groove 20 in the standard ground contact state, and FIG. 3 illustrates the groove 20 in the regular state. In the standard ground contact state, when groove 20 is located in a region directly below ground contact, a groove width W1a of groove 20 measured at the position of the projection portion 23 and a groove width W2a of the groove 20 measured at the position of an opening portion of the groove 20 and satisfy the relationship W1a/W2a≤0.75. Note that groove 20 located in the region directly below ground contact means a state in which the groove 20 is located directly below tire rotation axis.

In the pneumatic tire described above, the groove 20 formed in the outer surface of the tread portion 1 includes the projection portion 23 projecting into the groove 20 from at least one side surface 22, and when the groove 20 is located in the region directly below ground contact in the standard ground contact state, the groove width W1a of the groove 20 measured at the position of the projection portion 23 and the groove width W2a of the groove 20 measured at the position of the opening portion of the groove 20 satisfy the relationship W1a/W2a≤0.75. This can prevent a stone entered in the groove 20 from reaching the groove bottom 21 and thus effectively reduce stone drilling. As a result, cracks at groove bottom 21 due to stone biting can be effectively reduced. Accordingly, the cracks at groove bottom 21 can be prevented from reaching the belt layer 7 and damaging the belt layer 7 in advance, and thus the durability of the pneumatic tire can be prevented from decreasing or the pneumatic tire can be prevented from becoming impossible to be retreaded.

Here, W1a/W2a being larger than 0.75 causes insufficient effect of reducing stone drilling. In particular, the groove width W1a of the groove 20 measured at the position of the projection portion 23 and the groove width W2a of the groove 20 measured at the position of the opening portion of groove 20 preferably satisfy the relationship W1a/W2a≤0.5, and more preferably satisfy the relationship W1a/W2a≤0.2. W1a/W2a=0.0 (a state where the groove 20 is completely closed) is also a preferable mode.

In the pneumatic tire described above, groove 20 formed in the outer surface of the tread portion 1 preferably includes a structure in which the projection portion 23 projects into the groove 20 from one side wall 22 of the pair of side walls 22 but includes no projection portion 23 on the other side wall 22. The groove 20 in which the projection portion 23 is disposed only on one groove wall 22 as just described can effectively discharge the stone entered in the groove 20 and reduce stone drilling.

As illustrated in FIG. 2, when groove 20 is located in the region directly below ground contact in the standard ground contact state, a groove depth Da of the groove 20 and a height d1a of the projection portion 23 preferably satisfy the relationship 0.10≤d1a/Da≤0.70. Setting the height d1a of the projection portion 23 in the range above in relation to the groove depth Da of the groove 20 can effectively discharge the stone entered in the groove 20 and reduce stone drilling.

Here, d1a/Da being smaller than 0.10 does not have sufficient apparent under-groove rubber gauge during ground contact, thus decreasing the effect of reducing stone drilling. In contrast, d1a/Da being larger than 0.70 causes insufficient volume of the groove 20, thus decreasing wet performance. In particular, the groove depth Da of the groove 20 and the height d1a of the projection portion 23 preferably satisfy the relationship 0.15≤d1a/Da≤0.40.

As illustrated in FIG. 2, when groove 20 is located in the region directly below ground contact in the standard ground contact state, the groove depth Da of the groove 20 and a distance Ha from the belt layer 7 to the groove bottom 21 of the groove 20 preferably satisfy the relationship 0.1≤Ha/Da≤0.7. Setting the distance Ha from the belt layer 7 to the groove bottom 21 of the groove 20 in the range above in relation to the groove depth Da of the groove 20 can effectively reduce stone drilling while having sufficient volume of the groove 20.

Here, Ha/Da being smaller than 0.1 does not have sufficient apparent under-groove rubber gauge during ground contact, thus decreasing the effect of reducing stone drilling. In contrast, Ha/Da being larger than 0.70 does not have sufficient volume of the groove 20, thus decreasing wet performance. In particular, when groove 20 is located in the region directly below ground contact, the groove depth Da of the groove 20 and the distance Ha from belt layer 7 to the groove bottom 21 of the groove 20 preferably satisfy the relationship 0.15≤Ha/Da≤0.40.

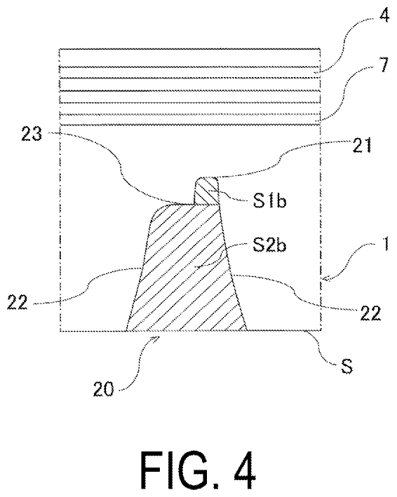

As illustrated in FIG. 4, in the regular state, a cross-sectional area S2b of the groove 20 from the opening portion of the groove 20 to the projection portion 23 (upward-sloping hatched portion) and a cross-sectional area S1b of the groove 20 from the projection portion 23 to the groove bottom 21 (downward-sloping hatched portion) preferably satisfy the relationship of S1b/S2b≤0.4. Setting cross-sectional area S1b of the groove 20 from the projection portion 23 to the groove bottom 21 in the range above in relation to the cross-sectional area S2b of the groove 20 from the opening portion of the groove 20 to the projection portion 23 causes a stone entered in the groove 20 to be less likely to enter the groove bottom 21 side and can thus reduce stone drilling.

Here, S1b/S2b being larger than 0.4 decreases the effect of reducing stone drilling. In particular, the cross-sectional area S2b of the groove 20 from the opening portion of the groove 20 to the projection portion 23 and the cross-sectional area S1b of the groove 20 from the projection portion 23 to groove bottom 21 preferably satisfy the relationship S1b/S2b≤0.2.

As illustrated in FIG. 3, in the regular state, the sum of a distance Hb from the belt layer 7 to the groove bottom 21 of the groove 20 and a height d1b of the projection portion 23 is preferably 6 mm or more. This increases the apparent under-groove rubber gauge during ground contact and can thus reduce stone drilling.

Here, when the value of Hb+d1b is less than 6 mm, the effect of reducing stone drilling decreases. The sum of the distance Hb from the belt layer 7 to the groove bottom 21 of the groove 20 and the height d1b of the projection portion 23 is preferably 6 mm or more, and 12 mm or less.

As illustrated in FIG. 3, in the regular state, the projection portion 23 preferably has a curved surface having a radius of curvature R at a portion connected to the side wall 22 and a curved surface having a radius of curvature R at a portion connected to the groove bottom 21, and preferably has a bent surface (corner) at an end portion in which the surface connected to the side wall 22 and the surface connected to the groove bottom 21 are coupled to each other. Strain concentrates on a portion of the projection portion 23 connected to the side wall 22, portion of projection portion 23 and connected to the groove bottom 21 during ground contact. Accordingly, by providing the curved surfaces on these portions, the concentration of strain can be avoided. Meanwhile, by providing the bent surface at an end portion in which the surface of the projection portion 23 connected to the side wall 22 and the surface of the projection portion 23 connected to the groove bottom 21 are coupled to each other, the entry of a stone toward the groove bottom side can be effectively prevented.

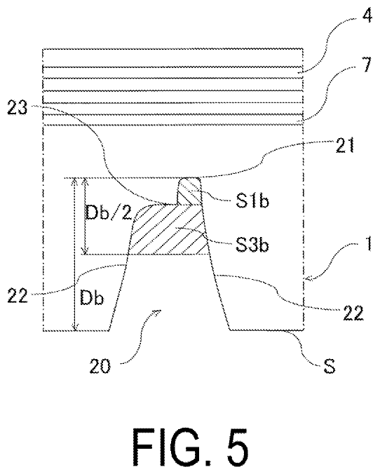

As illustrated in FIG. 5, in the regular state, a cross-sectional area S3b of the groove 20 from the position of half of a groove depth Db of the groove 20 to the projection portion 23 (upward-sloping hatched portion) and the cross-sectional area S1b of the groove 20 from the projection portion 23 to the groove bottom 21 (downward-sloping hatched portion) preferably satisfy the relationship of S1b/S3b≤0.6. Setting the cross-sectional area S1b of the groove 20 from the projection portion 23 to the groove bottom 21 in the range above in relation to the cross-sectional area S3b of the groove 20 from the position of half of the groove depth Db of the groove 20 to the projection portion 23 causes a stone entered in the groove 20 to be less likely to enter the groove bottom side even in a state where wear has progressed and can thus reduce stone drilling.

Here, S1b/S3b being larger than 0.6 decreases the effect of reducing stone drilling. In particular, the cross-sectional area S3b of the groove 20 from the position of half of the groove depth Db of the groove 20 to the projection portion 23 and the cross-sectional area S1b of the groove 20 from the projection portion 23 to the groove bottom 21 preferably satisfy the relationship S1b/S3b≤0.3.

As illustrated in FIG. 3, in the regular state, a groove width W1b of the groove 20 measured at the position of the projection portion 23 is preferably 1 mm or more and 8 mm or less. This can reduce stone drilling while having sufficient volume of the groove 20.

Here, the groove width W1b being smaller than 1 mm does not have sufficient volume of the groove 20, thus decreasing wet performance. In contrast, the groove width W1b being larger than 8 mm does not effectively close the groove 20 at the groove bottom side during ground contact, thus decreasing the effect of reducing stone drilling. In particular, the groove width W1b of the groove 20 measured at the position of the projection portion 23 is preferably 1 mm or more, and 4 mm or less.

The groove width W1b of the groove 20 measured at the position of the projection portion 23 in the regular state and the groove width W1a of the groove 20 measured at the position of the projection portion 23 in the standard ground contact state preferably satisfy the relationship W1a/W1b≤0.7. Setting the groove width W1a in the standard ground contact state in the range above with respect to the groove width W1b in the regular state can effectively prevent a stone entered in the groove 20 from reaching the groove bottom 21.

Here, W1a/W1b being larger than 0.7 causes insufficient effect of reducing stone drilling. In particular, the groove width W1b of the groove 20 measured at the position of the projection portion 23 in the regular state and the groove width W1a of the groove 20 measured at the position of the projection portion 23 in the standard ground contact state preferably satisfy the relationship W1a/W1b≤0.5, and more preferably satisfy the relationship W1a/W1b≤0.2. W1a/W1b=0.0 (a state where the groove 20 is completely closed) is also a preferable mode.

When groove 20 is located in the region directly below ground contact in the standard ground contact state, the pair of side walls 22 preferably have a shape bulging toward an inner side of groove 20. The pair of side walls 22 having a shape bulging toward the inner side of the groove 20 in the standard ground contact state improves discharging efficiency of a stone and can reduce stone drilling.

In the embodiment described above, the case where the specific groove shape is applied to the groove 20 extending in the tire circumferential direction in the outer surface of the tread portion 1 is described. However, in the present technology, the specific groove shape can be applied to the lug groove extending in the tire width direction.

### Examples

Pneumatic tires of Conventional Example and Examples 1 to 10 were manufactured. Each of the pneumatic tires includes a tread portion, a pair of sidewall portions, and a pair of bead portions. In the pneumatic tire, a carcass layer is mounted between the pair of bead portions, a belt layer is disposed on a radially outer side of the carcass layer, and grooves are formed in an outer surface of the tread portion. In the pneumatic tire, W1a/W2a, d1a/Da, Ha/Da, S1b/S2b, Hb+d1b, the presence of curved surfaces at portions of a projection portion, which are respectively connected to a side wall and a groove bottom, the presence of a bent surface at an end portion in which the surface of the projection portion connected to the side wall and the surface of the projection portion connected to the groove bottom are coupled to each other, S1b/S3b, W1b, W1a/W1b, and the presence of a bulging shape of the side walls in the standard ground contact state were set as shown in Table 1.

For these test tires, the effect of reducing stone drilling and wet braking ability were evaluated by the following test methods, and the results are shown in Table 1.

### Effect of Reducing Stone Drilling

Each test tire (11R22.5) was mounted on a specified rim of JATMA and mounted on a 2-D D dump truck, inflated to a specified air pressure of JATMA, and after traveling a certain distance off-road, the number of stones (stone drilling number) that have reached the groove bottom due to stone biting was measured. The evaluation results are expressed as index values using reciprocals of measurement values, with Conventional Example being assigned an index value of 100. Larger index values indicate higher effect of reducing stone drilling.

### Wet Braking Ability

Each test tire (275/80R22.5) was mounted on a specified rim of JATMA, mounted on a 2-D-4 truck, inflated to a specified air pressure of JATMA, and a braking distance starting from braking in a running state at a speed of 40 km/h on wet road surfaces to a stop was measured. The evaluation results are expressed as index values using reciprocals of measurement values, with Conventional Example being assigned an index value of 100. Larger index values indicate superior wet braking ability.

TABLE 1-1

| | Con- | Exam- | Exam- | Exam- | Exam- |
|---|---|---|---|---|---|
| | ventional | ple | ple | ple | ple |
| | Example | 1 | 2 | 3 | 4 |
| Presence of | Yes | Yes | Yes | Yes | Yes |
| projection portion | | | | | |
| W1a/W2a | 0.80 | 0.00 | 0.60 | 0.00 | 0.00 |
| d1a/Da | 0.75 | 0.75 | 0.75 | 0.20 | 0.20 |
| Ha/Da | 0.05 | 0.05 | 0.05 | 0.05 | 0.30 |
| S1b/S2b | 2.4 | 0.5 | 1.4 | 0.5 | 0.5 |
| Hb + d1b (mm) | 5.5 | 5.5 | 5.5 | 5.5 | 5.5 |
| Presence of curved | No | No | No | No | No |
| surface at | | | | | |
| connection portion | | | | | |
| Presence of | No | No | No | No | No |
| bent surface | | | | | |
| at end portion | | | | | |
| S1b/S3b | 1.5 | 0.7 | 1.0 | 0.7 | 0.7 |
| W1b (mm) | 0.9 | 0.9 | 0.9 | 0.9 | 0.9 |
| W1a/W1b | 4.8 | 0.0 | 3.2 | 0.0 | 0.0 |
| Presence of bulging | No | No | No | No | No |
| shape of side wall | | | | | |
| Effect of | 100 | 106 | 104 | 108 | 110 |
| reducing stone | | | | | |
| drilling | | | | | |
| (index value) | | | | | |
| Wet braking ability | 100 | 100 | 100 | 100 | 100 |
| index value) | | | | | |

TABLE 1-2

| | Exam- | Exam- | Exam- | Exam- | Exam- |
|---|---|---|---|---|---|
| | ple | ple | ple | ple | ple |
| | 6 | 7 | 8 | 9 | 10 |
| Presence of projection | Yes | Yes | Yes | Yes | Yes |
| portion | | | | | |
| W1a/W2a | 0.00 | 0.00 | 0.00 | 0.00 | 0.00 |
| d1a/Da | 0.20 | 0.20 | 0.20 | 0.20 | 0.20 |
| Ha/Da | 0.30 | 0.30 | 0.30 | 0.30 | 0.30 |
| S1b/S2b | 0.1 | 0.1 | 0.1 | 0.1 | 0.1 |
| Hb + d1b (mm) | 7.0 | 7.0 | 7.0 | 7.0 | 7.0 |
| Presence of curved surface | No | Yes | Yes | Yes | Yes |
| at connection portion | | | | | |
| Presence of bent | No | Yes | Yes | Yes | Yes |
| surface at end portion | | | | | |
| S1b/S3b | 0.7 | 0.7 | 0.2 | 0.2 | 0.2 |
| W1b (mm) | 0.9 | 0.9 | 0.9 | 1.0 | 1.0 |
| W1a/W1b | 0.0 | 0.0 | 0.0 | 10.0 | 0.0 |
| Presence of bulging shape | No | No | No | No | Yes |
| of side wall | | | | | |
| Effect of reducing stone | 113 | 114 | 115 | 116 | 117 |
| drilling (index value) | | | | | |
| Wet braking ability (index | 100 | 100 | 100 | 100 | 100 |
| value) | | | | | |

As can be seen from Table 1, the tires of Examples 1 to 10 were able to sufficiently exhibit the effect of reducing stone drilling while maintaining good wet braking ability.

The present disclosure includes the following Technologies [1] to [11].

Technology [1] is a pneumatic tire including:
a tread portion extending in a tire circumferential direction and having an annular shape;
a pair of sidewall portions disposed on respective both sides of the tread portion;
a pair of bead portions each disposed on an inner side of the pair of sidewall portions in a tire radial direction,
a carcass layer mounted between the pair of bead portions;
a belt layer disposed on a radially outer side of the carcass layer; and
a groove formed in an outer surface of the tread portion;
the groove including a groove bottom forming a maximum depth portion of the groove, a pair of side walls extending from a road contact surface of the tread portion to a side of the groove bottom, and a projection portion projecting into the groove from at least one side wall of the pair of side walls,
a state in which the pneumatic tire is mounted on a regular rim and inflated to a regular internal pressure being defined as a regular state, a state in which the pneumatic tire in the regular state is brought into contact with a flat surface and loaded with a load of 100% of a regular load being defined as a standard ground contact state, and
when the groove is located in a region directly below ground contact in the standard ground contact state, a groove width W1a of the groove measured at a position of the projection portion and a groove width W2a of the groove measured at a position of an opening portion of the groove satisfying a relationship W1a/W2a≤0.75.

Technology [2] is the pneumatic tire according to Technology [1], wherein the groove includes the projection portion projecting into the groove from the one side wall of the pair of side walls but includes no projection portion on the other side wall.

Technology [3] is the pneumatic tire according to Technology [1] or [2], wherein when the groove is located in the region directly below ground contact in the standard ground contact state, a groove depth Da of the groove and a height d1a of the projection portion satisfy a relationship 0.10≤d1a/Da≤0.70.

Technology [4] is the pneumatic tire according to any one of Technologies [1] to [3], wherein when the groove is located in the region directly below ground contact in the standard ground contact state, a groove depth Da of the groove and a distance Ha from the belt layer to the groove bottom of the groove satisfy a relationship 0.1≤Ha/Da≤0.7.

Technology [5] is the pneumatic tire according to any one of Technologies [1] to [4], wherein in the regular state, a cross-sectional area S2b of the groove from the opening portion of the groove to the projection portion and a cross-sectional area S1b of the groove from the projection portion to the groove bottom to satisfy a relationship S1b/S2b≤0.4.

Technology [6] is the pneumatic tire according to any one of Technologies [1] to [5], wherein in the regular state, a sum of a distance Hb from the belt layer to the groove bottom of the groove and a height d1b of the projection portion is 6 mm or more.

Technology [7] is the pneumatic tire according to any one of Technologies [1] to [6], wherein in the regular state, the projection portion has a curved surface at a portion connected to the side wall and a curved surface at a portion connected to the groove bottom and has a bent surface at an end portion in which a surface connected to the side wall and a surface connected to the groove bottom are coupled to each other.

Technology [8] is the pneumatic tire according to any one of Technologies [1] to [7], wherein in the regular state, a cross-sectional area S3b of the groove from a position of half of a groove depth Db of the groove to the projection portion and a cross-sectional area S1b of the groove from the projection portion to the groove bottom satisfy a relationship S1b/S3b≤0.6.

Technology [9] is the pneumatic tire according to any one of Technologies [1] to [8], wherein a groove width W1b of the groove measured at a position of the projection portion in the regular state is 1 mm or more and 8 mm or less.

Technology [10] is the pneumatic tire according to any one of Technologies [1] to [9], wherein a groove width W1b of the groove measured at a position of the projection portion in the regular state and the groove width W1a of the groove measured at the position of the projection portion in the standard ground contact state satisfy a relationship W1a/W1b≤0.7.

Technology [11] is the pneumatic tire according to any one of Technologies [1] to [10], wherein when groove is located in the region directly below ground contact in the standard ground contact state, the pair of side walls have a shape bulging toward an inner side of the groove.

What is claimed is:

1. A pneumatic tire, comprising:
a tread portion extending in a tire circumferential direction and having an annular shape;
a pair of sidewall portions disposed on respective both sides of the tread portion; and
a pair of bead portions each disposed on an inner side of the pair of sidewall portions in a tire radial direction;
a carcass layer mounted between the pair of bead portions;
a belt layer disposed on a radially outer side of the carcass layer; and,
a groove formed in an outer surface of the tread portion;
the groove comprising a groove bottom forming a maximum depth portion of the groove, a pair of side walls extending from a road contact surface of the tread portion to a side of the groove bottom, and a projection portion projecting into the groove from at least one side wall of the pair of side walls,
a state in which the pneumatic tire is mounted on a regular rim and inflated to a regular internal pressure being defined as a regular state, a state in which the pneumatic tire in the regular state is brought into contact with a flat surface and loaded with a load of 10000 of a regular load being defined as a standard ground contact state, and
when the groove is located in a region directly below ground contact in the standard ground contact state, a groove width W1a of the groove measured at a position of the projection portion and a groove width W2a of the groove measured at a position of an opening portion of the groove satisfying a relationship W1a/W2a≤0.75.

2. The pneumatic tire according to claim 1, wherein the groove comprises the projection portion projecting into the groove from the one side wall of the pair of side walls but comprises no projection portion on the other side wall.

3. The pneumatic tire according to claim 1, wherein when the groove is located in the region directly below ground contact in the standard ground contact state, a groove depth Da of the groove and a height d1a of the projection portion satisfy a relationship 0.10≤d1a/Da≤0.70.

4. The pneumatic tire according to claim 1, wherein when the groove is located in the region directly below ground contact in the standard ground contact state, a groove depth Da of the groove and a distance Ha from the belt layer to the groove bottom of the groove satisfy a relationship 0.1≤Ha/Da≤0.7.

5. The pneumatic tire according to claim 1, wherein in the regular state, a cross-sectional area S2b of the groove from the opening portion of the groove to the projection portion and a cross-sectional area S1b of the groove from the projection portion to the groove bottom satisfy a relationship S1b/S2b≤0.4.

6. The pneumatic tire according to claim 1, wherein in the regular state, a sum of a distance Hb from the belt layer to the groove bottom of the groove and a height d1b of the projection portion is 6 mm or more.

7. The pneumatic tire according to claim 1, wherein in the regular state, the projection portion has a curved surface at a portion connected to the side wall and a curved surface at a portion connected to the groove bottom and has a bent surface at an end portion in which a surface connected to the side wall and a surface connected to the groove bottom are coupled to each other.

8. The pneumatic tire according to claim 1, wherein in the regular state, a cross-sectional area S3b of the groove from a position of half of a groove depth Db of the groove to the projection portion and a cross-sectional area S1b of the groove from the projection portion to the groove bottom satisfy a relationship S1b/S3b≤0.6.

9. The pneumatic tire according to claim 1, wherein a groove width W1b of the groove measured at a position of the projection portion in the regular state is 1 mm or more and 8 mm or less.

10. The pneumatic tire according to claim 1, wherein a groove width W1b of the groove measured at a position of the projection portion in the regular state and the groove width W1a of the groove measured at the position of the projection portion in the standard ground contact state satisfy a relationship W1a/W1b≤0.7.

11. The pneumatic tire according to claim 1, wherein when the groove is located in the region directly below ground contact in the standard ground contact state, the pair of side walls have a shape bulging toward an inner side of the groove.

12. The pneumatic tire according to claim 2, wherein when the groove is located in the region directly below ground contact in the standard ground contact state, a groove depth Da of the groove and a height d1a of the projection portion satisfy a relationship 0.10≤d1a/Da≤0.70.

13. The pneumatic tire according to claim 12, wherein when the groove is located in the region directly below ground contact in the standard ground contact state, a groove depth Da of the groove and a distance Ha from the belt layer to the groove bottom of the groove satisfy a relationship 0.1≤Ha/Da≤0.7.

14. The pneumatic tire according to claim 13, wherein in the regular state, a cross-sectional area S2b of the groove from the opening portion of the groove to the projection portion and a cross-sectional area S1b of the groove from the projection portion to the groove bottom satisfy a relationship S1b/S2b≤0.4.

15. The pneumatic tire according to claim 14, wherein in the regular state, a sum of a distance Hb from the belt layer to the groove bottom of the groove and a height d1b of the projection portion is 6 mm or more.

16. The pneumatic tire according to claim 15, wherein in the regular state, the projection portion has a curved surface at a portion connected to the side wall and a curved surface at a portion connected to the groove bottom and has a bent surface at an end portion in which a surface connected to the side wall and a surface connected to the groove bottom are coupled to each other.

17. The pneumatic tire according to claim 16, wherein in the regular state, a cross-sectional area S3b of the groove from a position of half of a groove depth Db of the groove to the projection portion and a cross-sectional area S1b of the groove from the projection portion to the groove bottom satisfy a relationship S1b/S3b≤0.6.

18. The pneumatic tire according to claim 17, wherein a groove width W1b of the groove measured at a position of the projection portion in the regular state is 1 mm or more and 8 mm or less.

19. The pneumatic tire according to claim 18, wherein a groove width W1b of the groove measured at a position of the projection portion in the regular state and the groove width W1a of the groove measured at the position of the projection portion in the standard ground contact state satisfy a relationship W1a/W1b≤0.7.

20. The pneumatic tire according to claim 19, wherein when the groove is located in the region directly below ground contact in the standard ground contact state, the pair of side walls have a shape bulging toward an inner side of the groove.
